(19) United States
(12) Patent Application Publication
(10) Pub. No.: US 2007/0174193 A1
(43) Pub. Date: Jul. 26, 2007

(54) System and method for providing single sign-on functionality

(75) Inventors: Ha Quan, New York, NY (US); Stephen J. Remboski, West Hills, CA (US); Debra A. Baker, Marlboro, NY (US)

Correspondence Address: PILLSBURY WINTHROP SHAW PITTMAN, LLP, P.O. BOX 10500, MCLEAN, VA, 22102, US

(73) Assignee: THE BANK OF NEW YORK COMPANY, INC., New York, NY (US)

(21) Appl. No.: 11/335,694

(22) Filed: Jan. 20, 2006

(51) Int. Cl. G06Q 40/00

(52) U.S. Cl. 705/44

(57) ABSTRACT

Single sign on functionality is provided from a financial institution's financial services platform to at least one third party maintained application.

### BACKGROUND OF THE INVENTION

1. Field of the Invention

The present invention relates to security mechanisms for accessing software applications. In particular, the present invention relates to security mechanisms for accessing software applications provided by and/or maintained by more then one party.

2. Description of Related Art

In financial investments, achieving a proper balance between risk and reward requires more than just access to portfolio information. Thus, financial institutions that offer financial investment services conventionally offer access to specialized third-party maintained applications that can provide access to portfolio information as well as strategic advice tool functionality. For example, Wilshire™ Associates provides a dynamic performance and risk analysis functionality to its clients who may be clients or financial institution personnel. Wilshire provides peer group performance comparisons, including custom screening capabilities, via its Trust Universe Comparison Services (TUCS™) application. TUCS is based on an aggregation of more than 5,000 investment portfolios. It allows users to analyze a portfolio, an asset class within a portfolio, or the total plan in the context of the broadest available universe of relevant institutional portfolios. Comparative analyses can be made both monthly and quarterly.

Through TUCS' web-based access, users have access to performance comparison and analytics reporting capabilities, custom screening capabilities through a custom universe generator, report delivery in electronic format, access to financial institution custody portfolio data (returns and characteristics) resulting from processing of returns and holdings data submitted to Wilshire.

Conventionally, clients of a financial institution and internal users (i.e., users working as part of the organization(s), e.g., a financial institution, that provide various investment serves) access the TUCS application using a web browser and entering their login information, e.g., user id and password, issued by Wilshire. That same group of users may also have access to a financial institution's financial services platform, which requires a different set of login information, issued by the financial institution.

### BRIEF SUMMARY OF THE INVENTION

In accordance with at least one embodiment of the invention, single sign on functionality is provided from a financial institution's financial services platform to at least one third party maintained application.

In accordance with at least one embodiment of the invention, the at least one third party maintained application is the Wilshire TUCS Universe online application.

### BRIEF DESCRIPTION OF THE DRAWINGS

FIG. 1 illustrates a single sign-on functionality implementation methodology in accordance with one embodiment of the invention.

FIG. 2 illustrates one example of a private label TUCS landing page in full screen mode.

FIG. 3 illustrates one implementation of an embodiment providing single sign-on functionality in accordance with at least one embodiment of the invention.

FIG. 4 illustrates one example of a graphical user interface provided as part of a client setup process in accordance with at least one embodiment of the invention.

FIG. 5 illustrates one example of a graphical user interface provided as part of a sponsor setup process in accordance with at least one embodiment of the invention.

FIG. 6 illustrates one example of a graphical user interface provided as part of a user setup process in accordance with at least one embodiment of the invention.

FIG. 7 illustrates one example of a FORM link to the TUCS application in accordance with at least one embodiment of the invention.

### DETAILED DESCRIPTION OF THE INVENTION

In accordance with at least one embodiment of the invention access to at least one third party maintained application is provided via a hyperlink from a financial services platform's navigation menu. For example, in the context of TUCS, a hyperlink titled “TUCS” may be added under the “Risk Analysis” category of the “Services” menu on the financial services Global Navigation.

Thus, for a group of users who have access to both a financial institution's financial services platform and the Wilshire TUCS Universe application, a direct link is provided from the financial services platform to Wilshire's “private label” TUCS application without the need to re-enter their Wilshire specific login information. Users will have a single-login to access both the financial institution's suite of financial services products and also Wilshire's. The private label TUCS will have the look and feel that is consistent with the financial services platform. The private label TUCS will have the same user interface as available if a user were to log into TUCS directly via a web browser.

Since the TUCS application is hosted by Wilshire and the financial services platform user who has access to the TUCS application will be making requests to the TUCS server, additional computer resources need not be necessary to implement the invention. However, implementation of invention embodiments may require infrastructure configuration changes on the proxies or firewalls.

Upon accessing the Wilshire TUCS Universe online application via the single sign-on hyperlink via the financial services platform, the TUCS Universe application may present the user with access to the same products, services, and account access as though the financial services platform internal user logged in directly to the Wilshire TUCS Universe online application.

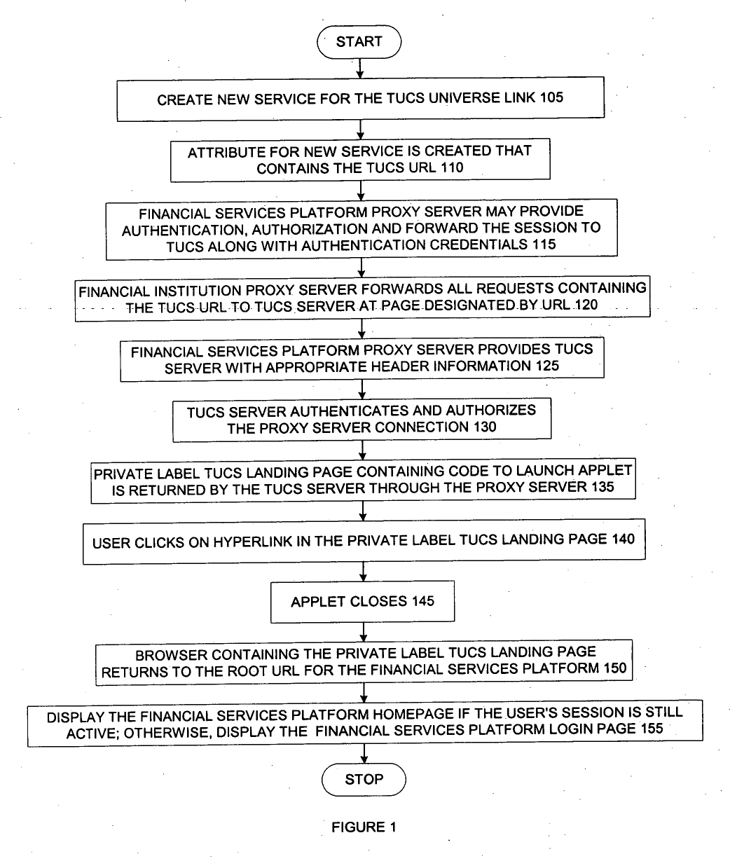

As illustrated in FIG. 1, in accordance with at least one embodiment of the invention, the single sign-on functionality may be implemented by first creating a new service for the Wilshire TUCS Universe link at 105. Subsequently, at 110, an attribute for the new service is created that contains the TUCS URL. Subsequently, at 115, the financial services platform proxy server may provide authentication, authorization and forward the session to TUCS along with authentication credentials: financial services platform user ID and session ID. The method continues to 120, at which a proxy server will forward all requests containing the TUCS URL to a TUCS server at the page designated by the URL. Then, at 125, the financial services platform proxy server may provide the TUCS server with the appropriate header information for the TUCS server to take appropriate action as required by the financial services platform proxy.

Subsequently, the TUCS server authenticates and authorizes the proxy server connection at 130. A private label TUCS landing page containing code to launch an applet is then returned by the TUCS server through the proxy at 135. Thus, any web page that resides on the TUCS server that may be accessed by a financial services platform user who logs into TUCS via the financial services platform's single sign-on will have a “Back to financial services platform” hyperlink.

Upon the user clicking at 140 on that hyperlink in the private label TUCS landing page, the applet closes at 145 and the browser containing the private label TUCS landing page returns at 150 to the root URL for the financial services platform. Subsequent to the applet closing, if the user's session is still active, the financial services platform homepage will be displayed at 155; otherwise, the financial services platform login page will be presented.

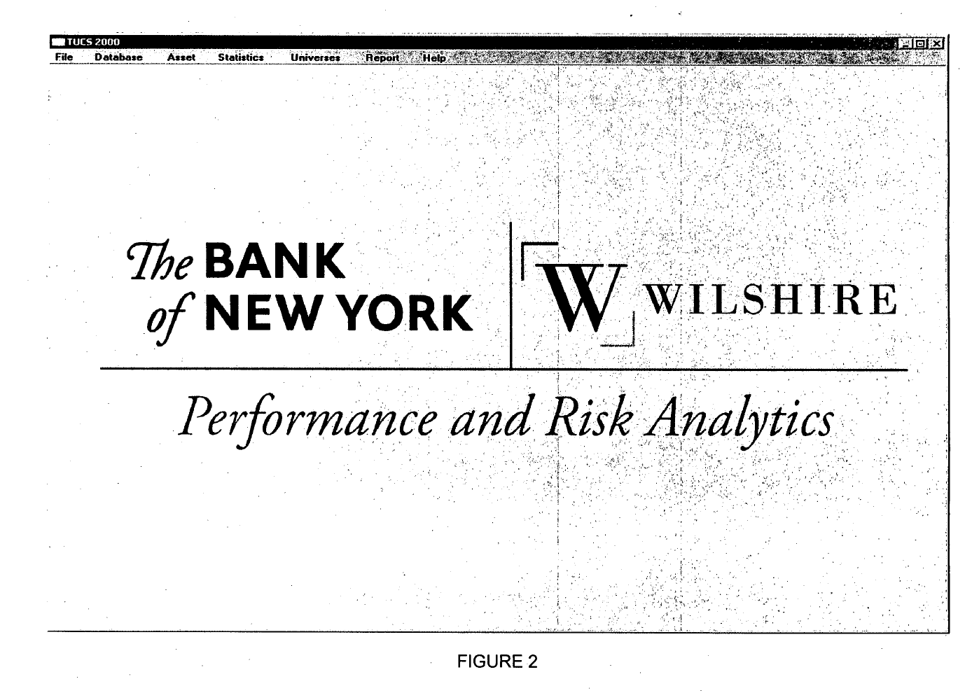

Subsequent selection of the TUCS hyperlink opens up the private label TUCS landing page in the same browser window; the page contains code that will launch the TUCS java applet in a separate applet window in full screen mode as illustrated in FIG. 2. Alternatively, the private label TUCS landing page may be loaded in the current browser window and include a “Back to financial services platform” link. In that implementation, upon the user clicking on the “Back to financial services platform” link in the private label TUCS landing page, the applet will close and the browser containing the private label TUCS landing page returns to the root URL for the financial services platform.

If the user changes the URL in the private label TUCS landing page to a URL that does not match that of the TUCS hyperlink, the applet will close.

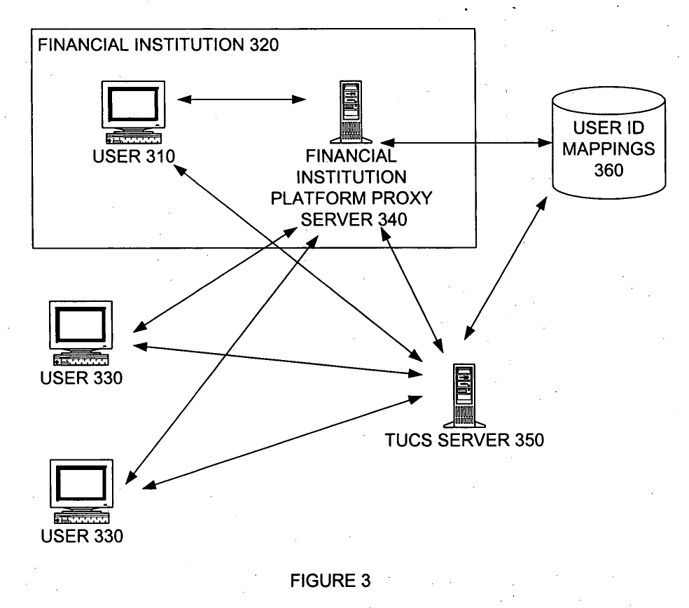

As illustrated in FIG. 3, a user 310 may interact located within a financial institution 320 or users 330 (separate or remote from the financial institution 320) may interact with a financial institution platform proxy server 340 to gain access to the TUCS server 350. Mappings 360 may be maintained of financial services platform user IDs to corresponding TUCS user IDs. Thus, the TUCS Universe application may only launch when the financial services platform user ID is in a TUCS ID map file located within the stored user ID mappings 360.

Upon login via a single sign-on link to the TUCS Universe online application, the application may present the user with access to the same products, services, and account access as though the user logged in directly to the TUCS Universe application. Alternatively, the products, services and account access may be customized to the private-label implementation, e.g., offering different, additional or some subset of products, services and access provided by direct access to the TUCS Universe application.

The TUCS Universe application may be configured to launch with a valid financial institution certificate, given a valid financial services platform user ID. Thus, prior to launching the TUCS applet, the TUCS server may detect if the certificate is from the financial institution and valid (non-expired).

Turning to session management, prior to responding to a user's request through an applet, the applet will first make a request to a web page on the TUCS server through the financial institution's proxy server to ensure that the current financial services platform user is currently authenticated and using a valid financial services platform session. If the proxy server, during the request to the web page on the TUCS server, provides a message to the TUCS server indicating that the current user session is invalid, then the applet will automatically close. The private label TUCS landing page may be redirected in accordance with the message provided by the financial services platform proxy server to the TUCS server. Session timeout will be based on the financial services platform's timeout rule (e.g., 20 minutes). If a financial services platform user directs his session to the TUCS application and works in the TUCS application for more than the financial services platform timeout allows, the financial services platform session management may keep the session alive by detecting the applet's constant polling of the web page on the TUCS server prior to the applet directly accessing TUCS.

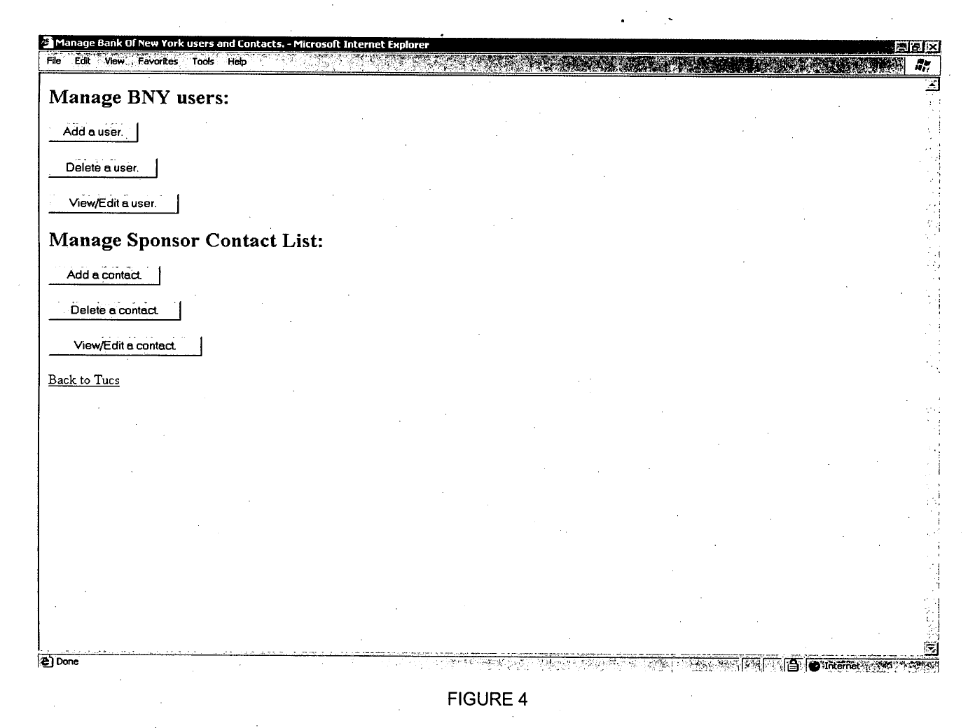

Various user interfaces may be implemented between the financial services platform and the TUCS universe. For example, FIG. 4 illustrates one example of a graphical user interface provided as part of a client setup process in accordance with at least one embodiment of the invention. As illustrated in FIG. 4, an operator may add, delete, view, and/or edit user information, for users within the financial institution providing the system providing single, sign-on functionality and those users at other organizations, for example, users at one or more sponsors, i.e., clients.

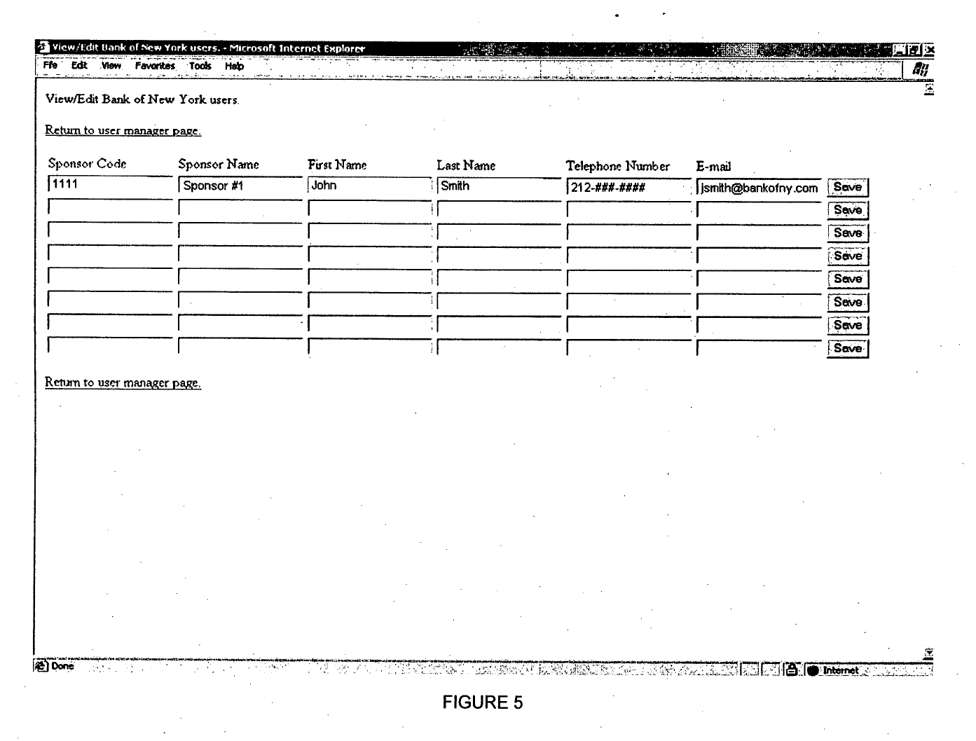

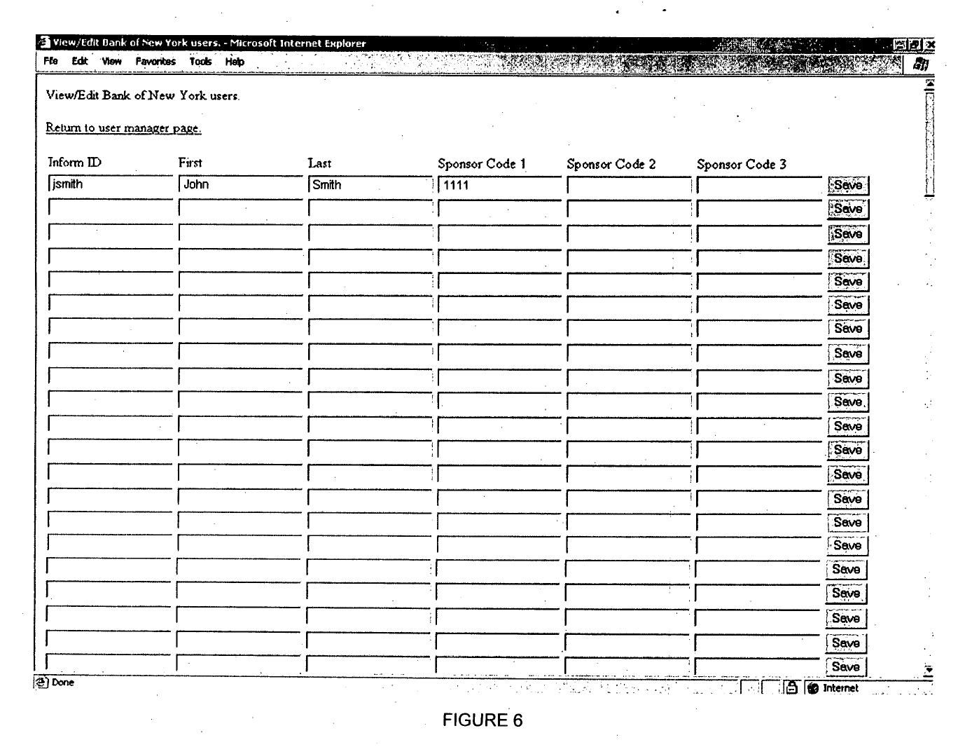

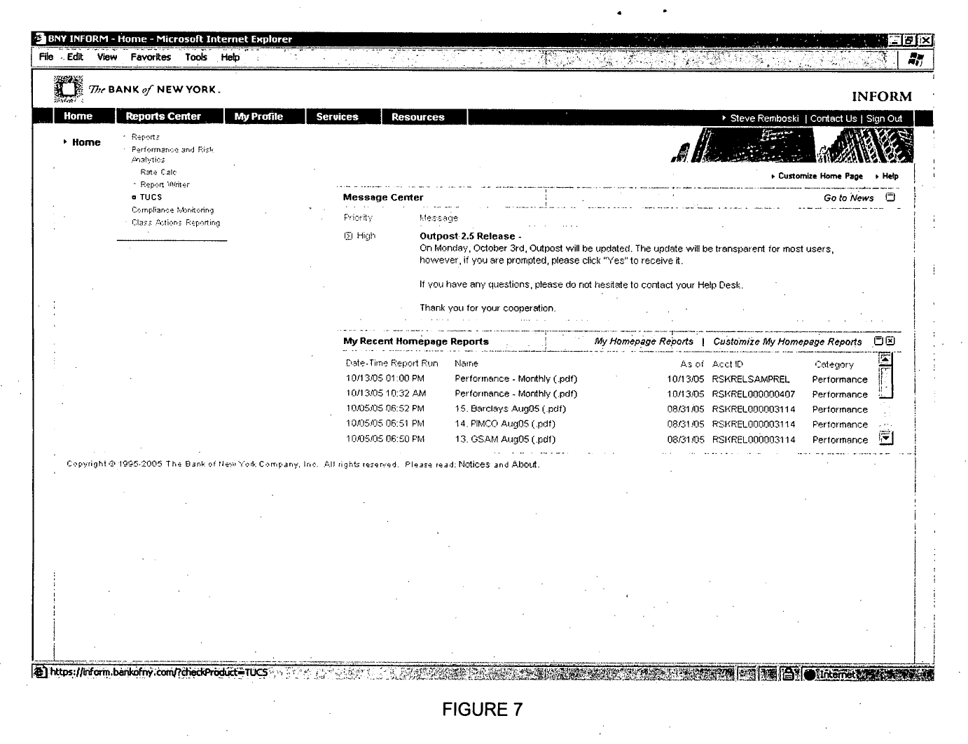

Further, as illustrated in FIG. 5, one or more graphical user interfaces may be provided as part of a sponsor setup process in accordance with at least one embodiment of the invention; in such an implementation data including client code, client name, and client contact information may be viewed and/or edited. By utilizing such graphical user interfaces, client accounts may be set up and associated with, i.e., mapped to one or more performance consultants at the financial institution that may be used in a Help function. FIG. 6 illustrates one example of a graphical user interface provided as part of a user setup process in accordance with at least one embodiment of the invention. By utilizing such graphical user interfaces, the system enables identification of financial institution assigned identification data and a name of a user as well as mapping that identification data with associated client codes Further, FIG. 7 illustrates one example of a FORM link to the TUCS application provided in accordance with at least one embodiment of the invention.

Additionally, secure SSL connections between the financial services platform servers and the TUCS server may be provided.

While this invention has been described in conjunction with the specific embodiments outlined above, it is evident that many alternatives, modifications and variations will be apparent to those skilled in the art. Accordingly, embodiments of the invention, as set forth above, are intended to be illustrative, not limiting. Various changes may be made without departing from the spirit and scope of the invention.

What is claimed is:

1. A financial services platform comprising:
at least one application maintained by a financial institution and being accessible by at least one user following input of a user identification code and password for the financial services platform; and
at least one application maintained by a third party and being accessible by the at least one user based on the user identification code and password for the financial services platform,
wherein the user identification code and password are mapped to another user identification code and password necessary to access the at least one application maintained by the third party.

2. The financial services platform of claim 1, wherein the at least one user has access to the at least one application maintained by the financial institution and the at least one application maintained by the third party following input of the user identification code and password for the financial services platform.

3. The financial services platform of claim 1, wherein the platform is implemented at least in part via at least one financial institution platform proxy server which interacts with at least one server supporting the at least one application maintained by the third party.

4. The financial services platform of claim 3, wherein the at least one financial institution platform proxy server accesses user identification mappings to identify the user identification code and password necessary to access the at least one application maintained by the third party.

5. The financial services platform of claim 1, wherein the at least one third party maintained application is the Wilshire™ TUCS™ application.

6. The financial services platform of claim 1, wherein access to the at least one third party maintained application is provided via a hyperlink from the financial services platform's navigation menu.

7. A method of providing single sign-on functionality in a financial services platform that includes at least one application maintained by a financial institution and being accessible by at least one user following input of a user identification code and password for the financial services platform and at least one application maintained by a third party and being accessible by the at least one user based on the user identification code and password for the financial services platform, the method comprising:
mapping the user identification code and password to another user identification code and password necessary to access the at least one application maintained by the third party.

8. The method of claim 7, wherein the at least one user has access to the at least one application maintained by the financial institution and the at least one application maintained by the third party following input of the user identification code and password for the financial services platform.

9. The method of claim 8, further comprising at least one financial institution platform proxy server which implements platform at least in part interacts with at least one server supporting the at least one application maintained by the third party to provide access to the at least one application maintained by the third party for the at least one user.

10. The method of claim 9, wherein the at least one financial institution platform proxy server accesses user identification mappings to identify the user identification code and password necessary to access the at least one application maintained by the third party.

11. The method of claim 10, further comprising the at least one financial institution platform proxy server provides authentication of the input user identification code and password, issues authorization to the user to access the financial services platform and forwards a session to the at least one server supporting the third party maintained application along with authentication credentials including the financial services platform user identification code and a session identification code.

12. The method of claim 11, further comprising the proxy server forwarding all requests containing a URL associated with the third party maintained application to the at least one server supporting the third party maintained application at the URL.

13. The method of claim 7, wherein the at least one third party maintained application is the Wilshire™ TUCS™ application.

14. The method of claim 7, wherein access to the at least one third party maintained application is provided via a hyperlink from the financial services platform's navigation menu.
